(19) United States
(12) Patent Application Publication
(10) Pub. No.: US 2025/0018610 A1
(43) Pub. Date: Jan. 16, 2025

(54) LARGE FORMAT VINYL ACETATE ETHYLENE CO-POLYMERS

(71) Applicant: Wacker Chemical AG, Munich (DE)

(72) Inventors: Suvrajyoti Kar, Ann Arbor, MI (US); James Kenny, Ann Arbor, MI (US); Ryan Salata, Ann Arbor, MI (US)

(73) Assignee: Wacker Chemical AG, Munich (DE)

(21) Appl. No.: 18/710,195

(22) PCT Filed: Dec. 29, 2022
(86) PCT No.: PCT/US2022/054285

§ 371 Date: May 15, 2024

Related U.S. Application Data
(60) Provisional application No. 63/295,173, filed on Dec. 30, 2021.

(51) Int. Cl. B29B 9/06; B29B 7/82; B29B 7/90; B29B 9/08; B29B 9/12

(52) U.S. Cl. CPC B29B 9/065; B29B 7/826; B29B 7/90; B29B 9/08; B29B 9/12

(57) ABSTRACT

Methods or processes for producing large format vinyl acetate ethylene (VAE) co-polymers along with uses and applications for the same. Where the process for producing large format vinyl acetate ethylene (VAE) co-polymers includes providing VAE co-polymers in the form of aqueous dispersions stabilized by one or more protective colloids and drying of said aqueous dispersions of VAE co-polymers in the presence of protective colloids to obtain VAE co-polymers in the form of water-redispersible powders. Where the drying of the aqueous dispersions is carried out by fluidized-bed drying, freeze drying or spray drying. Providing an amount of said dispersible VAE co-polymer powders and inserting an amount of said dispersible VAE co-polymer powders into an extruder or a roller compaction to form an amount of large format VAE pellets or granules.

### FIELD OF THE DISCLOSURE

The present disclosure relates to large format vinyl acetate ethylene (VAE) co-polymers. Additionally, the present disclosure relates to various methods of producing the large format VAE co-polymers for use in various applications.

### BACKGROUND OF THE DISCLOSURE

Currently, vinyl acetate ethylene (VAE) dispersible co-polymer powders made using conventional methods produce amounts of fines and/or dust that are undesirable. The dispersible VAE co-polymer powder fines and/or dust created using conventional processes have a particle size of less than 100 microns. Additionally, the dispersible VAE co-polymer powder fines and/or dust created using conventional processes are combustible when present in high concentrations in the air, which is disclosed as a hazard classification on the VAE product safety data sheet according to Environment, Health and Safety (EHS) standards. While some industries are accustomed to handling, using and/or transporting certain products that are classified as hazardous combustion products, many industries are not accustomed to and/or willing to take on the risks associated with using VAE products characterized as hazardous combustion products.

In light of the foregoing, it would therefore be advantageous to develop a method or process of producing large format VAE co-polymers that reduces or eliminates the overall amount of dispersible VAE co-polymer powder fines and/or dust created thereby reducing or eliminating the combustible dust hazard classification associated with certain dispersible VAE co-polymer powder products. Additionally, it would be advantageous to develop a method or process for producing large format VAE co-polymers that are pure or substantially pure VAE co-polymer as opposed to a composite. Furthermore, it would be advantageous to develop a method or process for producing large format VAE co-polymers that are free-flowing thereby allowing them to be reliably fed using a variety of feeding mechanisms.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 is a schematic perspective view of an extrusion machine for use in extruding an amount of large format VAE co-polymers according to an embodiment of the disclosure;

FIG. 2 is a schematic perspective view of the extrusion machine illustrated in FIG. 1 with an amount of extruded VAE material having exited a die;

FIG. 3 is a schematic top-view of an amount of extruded VAE pellets or granules produced according to the extrusion embodiment of the disclosure;

FIG. 4 is a schematic top-view of an amount of extruded VAE pellets or granules produced according to the extrusion embodiment of the disclosure;

FIG. 5 is a schematic top-view of a Sample A and a Sample B prepared and tested using extruded VAE pellets or granules created using the methods set forth herein;

FIG. 6 is a schematic illustration of a roller compaction process for producing VAE pellets or granules according to an embodiment of the disclosure;

FIG. 7 is a schematic top-view of an amount of VAE pellets or granules produced using the roller compaction embodiment of the disclosure; and

FIG. 8 is a schematic cross-sectional side-view an extrusion machine for use in a process for producing an amount of large format VAE co-polymers according to an embodiment of the disclosure.

### SUMMARY OF THE DISCLOSURE

Methods or processes for producing large format vinyl acetate ethylene (VAE) co-polymers along with uses and applications for the same. The methods or processes include providing an amount of VAE dispersible co-polymer powders which are inserted within an extruder or a roller compacter. The resulting VAE pellets and/or granules have eliminated or have a significantly reduced the amount of fines and/or dust which eliminates or significantly reduces the amount of highly combustible dust in the air. As a result, the VAE pellets or granules produced do not need to be classified as a hazardous combustion product.

### DETAILED DISCLOSURE

It is to be understood that the invention may assume various alternative orientations and step sequences, except where expressly specified to the contrary, it is also to be understood that the specific devices and processes illustrated in the attached drawings and described within the following specification are simply exemplary embodiments of the inventive concepts defined within the appended claims. Hence, the specific dimensions, directions, steps, processes and/or physical characteristics relating to the embodiments of the invention disclosed are not to be considered as limiting, unless the claims expressly state otherwise.

It is within the scope of this disclosure, and as a non-limiting example, that the large format VAE co-polymers produced by the methods or processes set forth herein may be provided as granules and/or pellets.

The present disclosure relates to large format vinyl acetate ethylene (VAE) co-polymers along with methods or processes for preparing the same and uses for the same. The VAE co-polymers are based on preferably ≥approximately 50 weight percent, more preferably approximately 60 to approximately 100 weight percent, even more preferably approximately 70 to approximately 95 weight percent and most preferably approximately 75 to approximately 85 weight percent of vinyl acetate, based on the total weight of the vinyl acetate-ethylene co-polymers.

The VAE co-polymers are based on preferably approximately 0 to approximately 40 weight percent, more preferably approximately 5 to approximately 30 weight percent and most preferably approximately 15 to approximately 25 weight percent of ethylene, based on the total weight of the VAE co-polymers.

The VAE co-polymers are based on preferably ≥approximately 90 weight percent, more preferably ≥95 weight percent and most preferably ≥approximately 97 weight percent of vinyl acetate and ethylene, based on the total weight of the VAE copolymers. Most preferably, the VAE co-polymers are not based on ethylenically unsaturated monomers other than vinyl acetate and ethylene.

The VAE co-polymers may be based on one or more further ethylenically unsaturated monomers, preferably selected from the group encompassing vinyl esters other than vinyl acetate, (meth)acrylic esters, vinylaromatics, dienes and/or vinyl halides, and optionally further monomers co-polymerizable therewith.

Examples for vinyl esters other than vinyl acetate are vinyl propionate, vinyl butyrate, vinyl 2-ethylhexanoate, vinyl laurate, 1-methylvinyl acetate, vinyl pivalate and/or vinyl esters of α-branched monocarboxylic acids having 9 to 11 C atoms, for example VeoVa9^{R} or VeoVa10^{R} (trade names of the company Resolution).

Additionally, examples for vinylaromatics are styrene, methylstyrene and vinyltoluene. Preferred vinyl halide is vinyl chloride. Preferred dienes are 1,3-butadiene and isoprene.

Furthermore, examples for (meth)acrylic esters are methyl acrylate, methyl methacrylate, ethyl acrylate, ethyl methacrylate, propyl acrylate, propyl methacrylate, n-butyl acrylate, n-butyl methacrylate, tert-butyl acrylate, tert-butyl methacrylate, 2-ethylhexyl acrylate. Preferred are methyl acrylate, methyl methacrylate, n-butyl acrylate, tert-butyl acrylate and/or 2-ethylhexyl acrylate.

Optionally it is possible for approximately 0% to <approximately 10% by weight, based on the total weight of the monomer mixture, of auxiliary monomers to be copolymerized. It is preferred to use approximately 0.1% to approximately 5% by weight of auxiliary monomers. Examples of auxiliary monomers are ethylenically unsaturated monocarboxylic and dicarboxylic acids, preferably acrylic acid, methacrylic acid, fumaric acid and maleic acid; ethylenically unsaturated carboxamides and carbonitriles, preferably acrylamide and acrylonitrile; monoesters and diesters of fumaric acid and maleic acid, such as the diethyl and diisopropyl esters, and also maleic anhydride; ethylenically unsaturated sulphonic acids and/or their salts, preferably vinylsulphonic acid, 2-acrylamido-2-methylpropanesulphonic acid. Further examples are precrosslinking comonomers such as polyethylenically unsaturated comonomers, examples being diallyl phthalate, divinyl adipate, diallyl maleate, allyl methacrylate or triallyl cyanurate, or postcrosslinking comonomers, examples being acrylamido glycolic acid (AGA), methylacrylamido glycolic acid methyl ester (MAGME), N-methylolacrylamide (NMA), N-methylolmethacrylamide, N-methylol allylcarbamate, alkyl ethers such as the isobutoxy ether or esters of N-methylolacrylamide, of N-methylolmethacrylamide and of N-methylol allylcarbamate. Also suitable are epoxide-functional comonomers such as glycidyl methacrylate and glycidyl acrylate. Further examples are silicon-functional comonomers, such as acryloyloxypropyltri (alkoxy)- and methacryloyloxypropyltri (alkoxy) silanes, vinyltrialkoxysilanes and vinylmethyldialkoxysilanes, where alkoxy groups that may be present include, for example, ethoxy radicals and ethoxypropylene glycol ether radicals. Mention may also be made of monomers having hydroxyl groups or CO groups, examples being hydroxyalkyl acrylates and methacrylates such as hydroxyethyl, hydroxypropyl or hydroxybutyl acrylate or methacrylate, and also compounds such as diacetoneacrylamide and acetylacetoxyethyl acrylate or methacrylate.

The monomer selection, and the selection of the weight fractions of the comonomers, are made such as to result in a glass transition temperature, Tg, of approximately −50° C. to approximately +30° C., preferably approximately −40° C. to approximately +10° C., more preferably approximately −30° C. to approximately 0° C. The glass transition temperature Tg of the polymers can be determined in a known way by means of Differential Scanning calorimetry (DSC). The Tg may also be calculated approximately in advance by means of the Fox equation. According to Fox T. G., Bull. Am. Physics Soc. 1, 3, page 123 (1956), the following holds: 1/Tg=x1/Tg1+x2/Tg2+ . . . +xn/Tgn, where xn is the mass fraction (% by weight/100) of the monomer n, and Tgn is the glass transition temperature, in kelvins, of the homopolymer of the monomer n. Tg values for homopolymers are listed in Polymer Handbook 2nd Edition, J. Wiley & Sons, New York (1975).

The VAE co-polymers are prepared generally in aqueous medium and preferably by the emulsion or suspension polymerization process as described in DE102008043988, for example. The VAE co-polymers in these cases are generally obtained in the form of aqueous dispersions. During the polymerization it is possible to use the common protective colloids and/or emulsifiers, as described in DE102008043988. Respective emulsifiers are described above. The protective colloids may be anionic or preferably cationic or non-ionic. Preference is also given to combinations of cationic and non-ionic protective colloids. Preferred non-ionic protective colloids are polyvinyl alcohols. Preferred cationic protective colloids are polymers which carry one or more cationic charges, as described in E. W. Flick, Water Soluble Resins an Industrial Guide, Noyes Publications, Park Ridge, N.J., 1991, for example.

The VAE co-polymers are preferably stabilized by one or more protective colloids. More preferably, the VAE co-polymers are applied in the form of aqueous dispersions stabilized by one or more protective colloids. Preferred as protective colloids are polyvinyl alcohols, particularly partially hydrolysed or fully hydrolysed polyvinyl alcohols having a degree of hydrolysis of approximately 80 to approximately 100 mol %, more particularly partially hydrolysed polyvinyl alcohols having a degree of hydrolysis of approximately 80 to approximately 94 mol % and/or a Höppler viscosity, in 4% strength aqueous solution, of approximately 1 to approximately 30 mPas (Höppler method at 20° C., DIN 53015). The stated protective colloids are obtainable by means of processes known to the skilled person, and are added in an amount totalling approximately 1% to approximately 20% by weight, based on the total weight of the monomers, in the polymerization.

The vinyl acetate-ethylene copolymers in the form of aqueous dispersions have solid contents of preferable approximately 30% to approximately 75%, more preferably approximately 45% to approximately 60%.

The polymers in the form of aqueous dispersions can, as described, for example, in DE 102008043988 A be converted into corresponding water-redispersible powders. Here, a drying aid is generally used in a total amount of from approximately 3 to approximately 30% by weight, preferably from approximately 5 to approximately 20% by weight, based on the polymeric constituents of the dispersion. As drying aids, preference is given to the above-mentioned polyvinyl alcohols. Preference is thus given to polymers in the form of water-redispersible powders stabilized by protective colloid.

Polymers in the form of water-redispersible powders (or polymer powders) are, powder compositions which are made available by means of drying of the corresponding aqueous polymer dispersions in the presence of protective colloids. On the basis of this production process, the finely divided polymer resin of the dispersion is enveloped with a water-soluble protective colloid in sufficient quantity. In the course of drying, the protective colloid acts like a jacket, preventing the particles from sticking to one another. On redispersing of the polymer powders in water, the protective colloid dissolves again in water to give an aqueous dispersion of the original polymer particles (Schulze J. in TIZ, No. 9, 1985).

The drying of the dispersions may, for example, be carried out by means of fluidized-bed drying, freeze drying and/or spray drying. The dispersions are preferably spray dried. Spray drying is carried out in conventional spray drying plants, with atomization being able to be effected by means of one-fluid, two-fluid or multifluid nozzles or by means of a rotating disk. The exit temperature is generally selected in the range from approximately 45° C. to approximately 120° C., preferably from approximately 60° C. to approximately 90° C., depending on the plant, the Tg of the resin and the desired degree of drying. The viscosity of the feed to be atomized is set via the solids content so that a value of <approximately 500 mPas (Brookfield viscosity at approximately 20 revolutions and approximately 23° C.), preferably <approximately 250 mPas, is obtained. The solids content of the dispersion to be atomized is preferably from 30 to 75% by weight and particularly preferably from approximately 50 to approximately 60% by weight.

In carrying out the atomization, a content of up to approximately 1.5% by weight of antifoam, based on the polymer, has frequently been found to be useful. To increase the storability by improving the caking stability, in particular in the case of polymer powders having a low glass transition temperature, the polymer powder obtained can be provided with one or more anticaking agents (antiblocking agents), preferably from approximately 1 to approximately 30% by weight, based on the total weight of polymeric constituents. Examples of anticaking agents are Ca carbonate or Mg carbonate, talc, gypsum, silica, kaolins such as metakaolin, silicates having particle sizes which are preferably in the range from approximately 10 nm to approximately 10 μm. The anticaking agents are different from the stabilizers according to the invention. The anticaking agents can be used in addition to the stabilizers according to the invention.

To improve the use properties, additives such as pigments, fillers, foam stabilizers, hydrophobicizing agents and/or cement plasticizers can be additionally added for drying.

In a first embodiment of the disclosure and as a non-limiting example, the large format VAE co-polymers may be produced using a process 100 which includes the use of an extruder 102. Extruders are used to create objects having a fixed substantially uniform cross-sectional profile by pushing an amount of material, such as an amount of VAE dispersible co-polymer powders, through one or more dies 104 having the desired cross-sectional shape. Because the extrusion process 100 only exposes the extruded material 106 to compressive and shear stresses, materials that may otherwise be too brittle to be formed to shape may be used. It is within the scope of this disclosure and as a non-limiting example that the extrusion process 100 may be a continuous or a semi-continuous process. Additionally, it is within the scope of this disclosure and as a non-limiting example that the extruder 102 may be a single screw extruder or a multi-screw extruder such as but not limited to a twin-screw extruder. Furthermore, it is within the scope of this disclosure and as a non-limiting example that the VAE dispersible co-polymers powder may be pure VAE or a substantially pure VAE co-polymer. When referring to pure VAE co-polymer it is meant that only VA (or vinyl acetate) and E (or ethylene) monomers and no other monomers are present within the co-polymer composition.

According to an embodiment of the disclosure and as a non-limiting example, the one or more screws (not shown) of the extruder 102 may be operably configured to rotate at a speed of approximately 40 rpm to approximately 300 rpm to achieve the desired extruded VAE material 106 or more preferably from approximately 40 rpm to approximately 65 rpm to achieve the desired extruded VAE material 106.

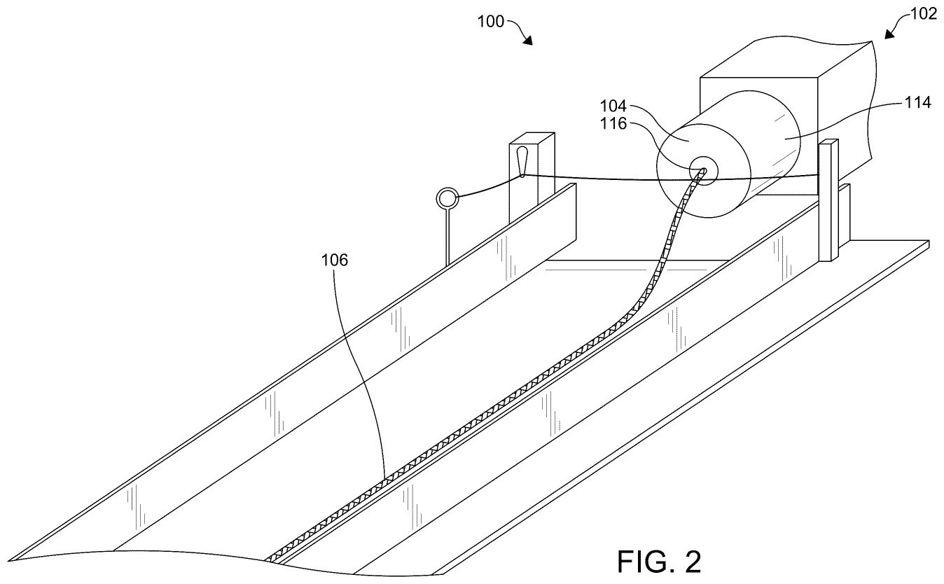

As illustrated in FIG. 2 and as a non-limiting example, the extruded VAE material 106 may have a substantially rope like shape.

It is within the scope of this disclosure and as a non-limiting example that the one or more screws (not shown) may include one or more screw elements (not shown). The one or more screw elements (not shown) may be disposed in a substantially linear manner one after another from one or more driving mechanisms (not shown) toward one or more dies 104 along the length of the extruder 102. According to this embodiment of the disclosure and as a non-limiting example, the one or more screws (not shown), and the one or more screw elements (not shown) may be drivingly connected to each other thereby allowing the one or more driving mechanisms (not shown) to drive the one or more screws (not shown) as needed to transform the VAE dispersible co-polymer powders into the desired large format VAE pellets or granules 106 and/or 108.

Additionally, it is within the scope of this disclosure and as a non-limiting example that the one or more screws (not shown), and the one or more screw elements (not shown) making up the one or more screws (not shown), may be oriented adjacent to or off-set from one another similar to that of a twin-screw extruder. As a non-limiting example, the one or more screws (not shown), and the one or more screw elements (not shown) making up the one or more screws (not shown), may be off-set from one another in a substantially parallel manner, at an angle such that the one or more screws (not shown) and the one or more screw elements (not shown) making up the one or more screws (not shown) disposed near the one or more dies 104 are further from each other than the space between the one or more screws (not shown) and the one or more screw elements (not shown) making up the one or more screws (not shown) near the one or more drive mechanisms (not shown) or at an angle such that the one or more screws (not shown) and the one or more screw elements (not shown) making up the one or more screws (not shown) disposed near the one or more dies 104 are closer together than the space between the one or more screws (not shown) and the one or more screw elements (not shown) making up the one or more screws (not shown) near the one or more drive mechanisms (not shown). This may be done in order to apply an amount of heat, pressure and force needed to transform the dispersible VAE co-polymer powders (not shown) into the desired large format VAE pellets or granules 106 and/or 108 without negatively affecting the overall life durability and/or properties of the large format VAE pellets or granules 106 and/or 108 created using the process 100.

According to an embodiment of the disclosure and as a non-limiting example, the above-described orientations and arrangements for the one or more screws (not shown), and the one or more screw elements (not shown) making up the one or more screws (not shown), may be combined in order to transform the dispersible VAE co-polymer powders (not shown) into the desired large format VAE pellets or granules 106 and/or 108.

The extruder 102 may include one or more zones (not shown) which may be heated or cooled accordingly in an effort to transform the dispersible VAE co-polymer powders (not shown) into the desired large format VAE pellets or granules 106 and/or 108. The one or more zones (not shown) may have a pre-determined temperature profile needed to create the large format VAE pellets or granules 106 and/or 108 in a manner that will not negatively affecting the overall life durability and/or properties of the large format VAE pellets or granules 106 and/or 108 created using the process 100. While the temperature profiles do not negatively affect the viscosity of the dispersible VAE co-polymer powders (not shown), higher temperatures do result in a degradation of the overall tackiness, life, durability and/or properties large format VAE pellets or granules 106 and/or 108 created using the process 100. According to an embodiment of the disclosure and as a non-limiting example one or more of the one or more zones (not shown) may have a temperature profile of approximately 100° C. to approximately 220° C., from approximately 125° C. to approximately 200° C., from approximately 140° C. to approximately 190° C., from approximately 160° C. to approximately 175° C.

In accordance with the embodiment of the disclosure where the extrusion process 100 may be a continuous process, the extruded VAE material 106 may have to subsequently broken down into smaller pieces until it reaches the desired particle size or falls within the desired particle size distribution. It is within the scope of this disclosure and as a non-limiting example that the extruded VAE material 106 may be subsequently broken down into pieces having a size from approximately 0.2 mm to approximately 12.5 mm, preferably from approximately 0.5 mm to approximately 10.5 mm or more preferably from approximately 1.0 mm to approximately 8 mm.

In accordance with the embodiment of the disclosure where the extrusion process 100 may be a semi-continuous process, the extruded VAE material 106 may be extruded into pellets or granules having a pre-determined particle size. These extruded VAE pellets or granules 108 may then me subsequently broken down into smaller pellets or granules until the VAE material 106 reaches its pre-determined desired particle size or falls within the desired particle size distribution. It is within the scope of this disclosure and as a non-limiting example that the extruded VAE pellets or granules 108 may be subsequently broken down into pieces having a size from approximately 0.2 mm to approximately 12.5 mm, preferably from approximately 0.5 mm to approximately 10.5 mm or more preferably from approximately 1.0 mm to approximately 8 mm.

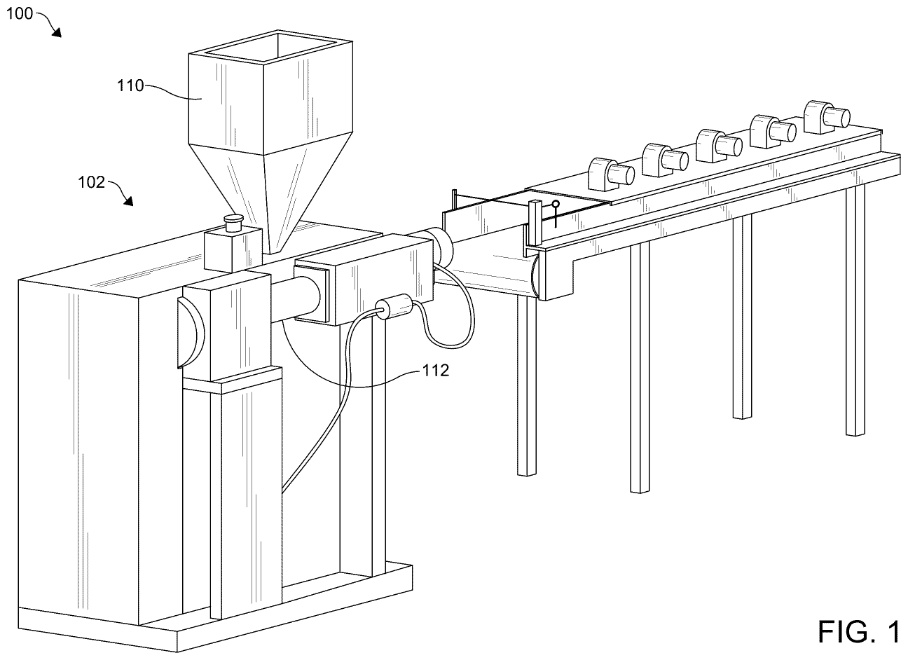

As illustrated in FIGS. 1 and 2 of the disclosure and as a non-limiting example, an amount of dispersible VAE co-polymer powder (not shown) is placed within a hopper 110 that is connected to a first end portion 112 of the extruder 102. Through the hopper 110, a substantially continuous amount of the dispersible VAE co-polymer powder (not shown) is inserted into the first end portion 112 of the extruder 102 and into a hollow interior portion (not shown) of the extruder 102. Once within the hollow interior portion (not shown) of the extruder 102, the dispersible VAE co-polymer powder (not shown) is heated, cooled, and/or compressed as the dispersible VAE co-polymer powder (not shown) is pushed through one or more dies 104 that is connected to a second end portion 114 of the extruder 102. The one or more dies 104 at the second end portion 114 of the extruder 102 has one or more openings 116 with a pre-determined cross-sectional shape. As best seen in FIG. 2 of the disclosure and as a non-limiting example, the extruded VAE materials 106 and/or 108 may have a substantially cylindrical, egg, ellipsoid, oval and/or ovoid shape.

The extruded VAE materials exiting the extruder 106 and/or 108 may be subjected to one or more cooling processes (not shown) as needed. It is within the scope of this disclosure and as a non-limiting example that the extruded VAE materials 106 and/or 108 exiting the extruder may be cooled using one or more coolers, air cooled on a conveyor belt and/or cooled by placing at least a portion of the extruded VAE materials 106 and/or 108 within a water bath.

As previously discussed, it is within the scope of this disclosure and as a non-limiting example that the extrusion process 100 may include one or more heating processes (not shown) where an amount of heat may be applied to the dispersible VAE co-polymer powder (not shown) during the extrusion process 100. This may be achieved by, having one or more zones (not shown) of the extruder 102 being operably configured to subject the dispersible VAE co-polymer powder (not shown) to a pre-determined temperature. It is within the scope of this disclosure and as a non-limiting example that one or more of the one or more zones (not shown) of the extruder 102 may be configured to heat the dispersible VAE co-polymer powder (not shown) to approximately 120° C. to approximately 220° C. or more preferably from approximately 120° C. to 160° C.

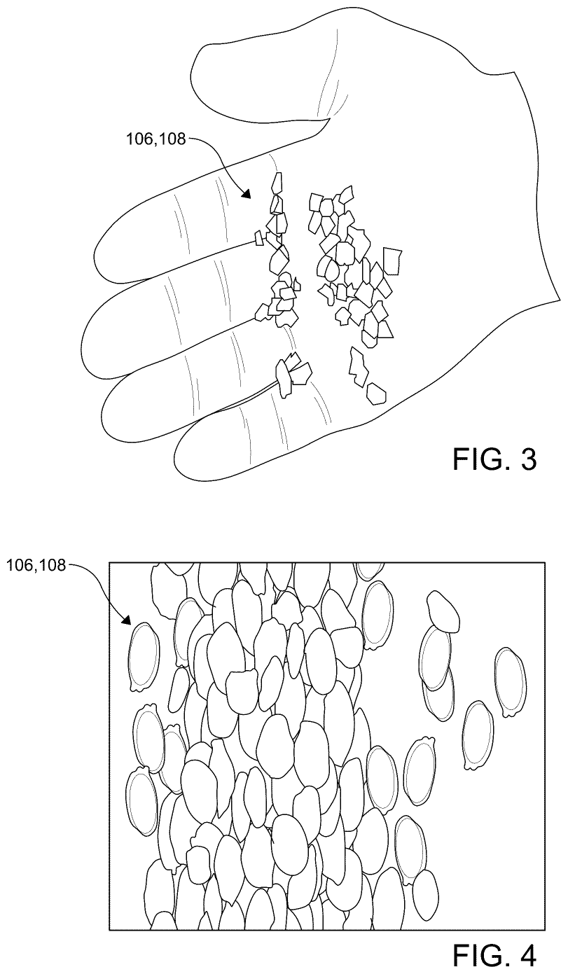

FIG. 3 illustrates an amount of VAE pellets or granules 106 and/or 108 that were produced using the extrusion process 100 described and illustrated herein. The extruded VAE pellets or granules 106 and/or 108 produced are substantially free-flowing and do not agglomerate or otherwise collect or otherwise group together to form a larger mass. By providing extruded VAE pellets or granules 106 and/or 108 that are free-flowing, it allows the extruded VAE pellets or granules 106 and/or 108 to be reliably fed using a variety of feeding mechanisms (not shown) and to be reliably and evenly mixed into or otherwise incorporated within a variety of products. As a result, by providing extruded VAE pellets or granules 106 and/or 108 that are substantially free-flowing and resist agglomerating, the extruded VAE pellets or granules 106 and/or 108 are able to be mixed into or otherwise incorporated within a wider array of applications or products.

In accordance with an embodiment of the disclosure and as a non-limiting example, the extruded VAE pellets or granules 106 and/or 108 may be an ETONIS® 7622 A and/or 7601 A.

It is within the scope of this disclosure and as a non-limiting example that the extruded VAE pellets or granules 106 and/or 108 may be a pure VAE or a substantially pure VAE co-polymer.

VAE materials having a lower glass transition temperature (Tg) are softer than those with a higher glass transition temperature (Tg) and tend to agglomerate or otherwise collect or group together to form a larger mass, which is undesirable as it negatively affects the ability of the extruded VAE pellets or granules 106 and/or 108 to be free-flowing. The issue may be eliminated or otherwise mitigated by using one or more first anti-caking agents (not shown). The one or more first anti-caking agents (not shown) are an additive that may be added to the dispersible VAE co-polymer powder (not shown) at a pre-determined amount during and/or prior to the extrusion process 100. As a non-limiting example, the one or more first anti-caking agents (not shown) used may have a particle size of approximately 2 to approximately 30 microns. It is within the scope of this disclosure and as a non-limiting example that the one or more first anti-caking agents (not shown) may be talcum powder, calcium carbonate, tricalcium phosphate, powdered cellulose, magnesium stearate, sodium bicarbonate, sodium ferrocyanide, potassium ferrocyanide, calcium ferrocyanide, bone phosphate, calcium phosphate, sodium silicate, silicon dioxide, calcium silicate, magnesium trisilicate, sodium aluminosilicate, potassium aluminium silicate, calcium aluminosilicate, bentonite, aluminium silicate, stearic acid, ethylene bis stearamide and/or polydimethylsiloxane. Additionally, as a non-limiting example, the one or more first anti-caking agents (not shown) may be added at approximately 3% to approximately 10% based on the weight of the dispersible VAE co-polymer powder (not shown) or more preferably added at approximately 5% based on the weight of the VAE dispersible co-polymer powder (not shown).

It is within the scope of this disclosure and as a non-limiting example that an amount of the one or more second anti-caking agents (not shown) may be added to the extruded VAE pellets or granules 106 and/or 108 as one or more post treatment processes. As a non-limiting example, the one or more second anti-caking agents (not shown) used may have a particle size of approximately 2 to approximately 30 microns. It is within the scope of this disclosure and as a non-limiting example that the one or more second anti-caking agents (not shown) may be talcum powder, calcium carbonate, tricalcium phosphate, powdered cellulose, magnesium stearate, sodium bicarbonate, sodium ferrocyanide, potassium ferrocyanide, calcium ferrocyanide, bone phosphate, calcium phosphate, sodium silicate, silicon dioxide, calcium silicate, magnesium trisilicate, sodium aluminosilicate, potassium aluminium silicate, calcium aluminosilicate, bentonite, aluminium silicate, stearic acid, ethylene bis stearamid and/or polydimethylsiloxane. Additionally, as a non-limiting example, the one or more second anti-caking agents (not shown) added to the extruded VAE pellets or granules 106 and/or 108 after the extrusion process 100 may be the same as or different from the one or more first anti-caking agents (not shown) added during or before the extrusion process 100. Furthermore, as a non-limiting example, the one or more second anti-caking agents (not shown) may be added at approximately 0.5% to approximately 5% based on the weight of the extruded VAE pellets or granules.

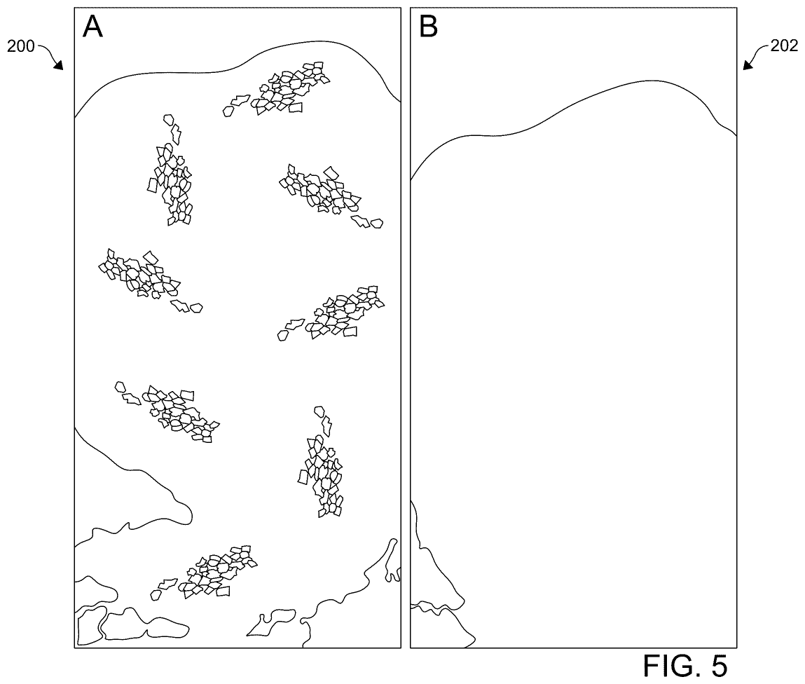

It is within the scope of this disclosure and as a non-limiting example that the extruded VAE pellets or granules 106 and/or 108 may be further reduced to a pre-determined particle size as part of the one or more post treatment processes (not shown). The one or more post treatment processes (not shown) may also be utilized in order to alter the overall surface area, cross-sectional shape and/or overall shape of the extruded VAE pellets or granules 106 and/or 108 thereby allowing the extruded VAE pellets or granules 106 and/or 108 to be customized as needed. An example of this can be seen within FIG. 4 of the instant application.

Additionally, it is within the scope of this disclosure and as a non-limiting example that the one or more post treatment processes (not shown) may be one or more pelletizing and/or granulation process (not shown). As a non-limiting example, the one or more pelletizing and/or granulation process (not shown) for the extruded VAE pellets or granules 106 and/or 108 may be an underwater pelletizing and/or underwater granulation process.

VAE materials having a higher glass transition temperature (Tg) are stiffer and therefore tend to resist agglomeration or otherwise collecting or grouping up together to form a larger mass. As a result, it is within the scope of this disclosure and as a non-limiting example that VAE materials having a higher glass transition temperature (Tg) may not require the addition of the one or more first anti-caking agents or the one or more second anti-caking agents.

As a non-limiting example, the dispersible VAE co-polymer powder (not shown) utilized within the extrusion process 100 may have a glass transition temperature (Tg) from approximately −20° C. to approximately 25° C. The glass transition temperature (Tg) of the dispersible VAE co-polymer powder (not shown) may be altered or modified as needed by adjusting the amount of ethylene within the dispersible VAE co-polymer powder (not shown).

The extruded VAE pellets or granules 106 and/or 108 produced using the extrusion process 100 described and illustrated herein do not create the undesirable fines and/or dust that are combustible and hazardous. As a result, the extruded VAE pellets or granules 106 and/or 108 produced using the extrusion process 100 set forth herein do not need to be classified as a hazardous combustible product according to EHS standards.

Additionally, the extruded VAE pellets or granules 106 and/or 108 produced using the extrusion method 100 have a more consistent particle size distribution (PSD) as opposed to those which are produced using conventional methods. This is desirable for applications having tighter tolerances or requiring a specific particle size. It is within the scope of this disclosure and as a non-limiting example that the PSD may be from approximately 0.2 mm to approximately 12.5 mm, preferably from approximately 0.5 mm to approximately 10.5 mm or more preferably from approximately 1.0 mm to approximately 8 mm.

Furthermore, the extruded VAE pellets or granules 106 and/or 108 produced using the extrusion method 100 do not negatively affect the overall bulk density when compared to the dispersible VAE co-polymer powders created using conventional methods. As a result, the extruded VAE pellets or granules 106 and/or 108 produced using the extrusion method 100 set forth herein are able to be easily and safely packaged and transported.

Still further, the extruded VAE pellets or granules 106 and/or 108 produced using the extrusion method 100 set forth herein have a moisture content of approximately 3% or less. This aids in ensuring that the shelf life and/or storage stability of the extruded VAE pellets and/or granules 106 and/or 108 are not negatively impacted when compared to dispersible VAE co-polymer powders created using conventional methods. It is within the scope of this disclosure and as a non-limiting example that the moisture content of the extruded VAE pellets or granules 106 and/or 108 may be reduced using one or more post drying processes (not shown). As a non-limiting example, the one or more post drying processes (not shown) may be achieved by placing an amount of the extruded VAE pellets or granules 106 and/or 108 into an oven and/or a drum dryer (not shown) at approximately 80° C. to approximately 120° C. Preferably, the oven and/or the drum dryer (not shown) may be set at approximately 95° C. to approximately 105° C.

It is within the scope of this disclosure and as a non-limiting example that the extruded VAE pellets or granules 106 and/or 108 having the desired pre-determined particle size may be utilized as chemical products in the construction industry in conjunction with hydraulically setting binders such as cements (Portland cement, high-alumina cement, trass cement, glass furnace cement, magnesia cement, phosphate cement), gypsum and waterglass, for the production of construction adhesives, especially tile adhesives and thermal insulation composition system adhesives, renders, filling compounds, flooring compounds, levelling compounds, grouts, jointing mortars and/or paints. Further examples are as binders for coating materials and adhesive-bonding materials, or as coating agents and/or binding agents for textiles and/or paper. Additionally, it is within the scope of this disclosure and as a non-limiting example that the extruded VAE pellets or granules may be used within cementitious type products, asphalt related products, asphalt roofing products, high temperature applications, high shear applications and/or other construction related products.

As best seen in FIG. 5 of the disclosure and as a non-limiting example, a Sample A 200 was created using the extruded VAE pellets or granules 106 and/or 108 created using the extrusion method 100 set forth herein and a Sample B 202 was created using conventional VAE dispersible co-polymer powders. The Sample A 200 and Sample B 202 are asphalt compositions. The drawdown texture of the Sample A 200 shows some pellets and/or granules while the drawdown texture of the Sample B 202 is smoother. However, as set forth within Table 1 of the disclosure provided below, both Sample A 200 and Sample B 202 had substantially similar performance.

TABLE 1

| | 7622 A | 7622 A |
|---|---|---|
| | pellet | powder |
| Properties | Sample A | Sample B |
| Rotational viscosity (cP) @ 135° C., S21, 20 rpm | 380 | 427 |
| G*/sin δ @ 58° C., kPa | 1.83 | 1.81 |
| Phase angle (δ) @ 58° C. | 85.5° | 86.1° |
| High temp. grade, ° C. | 58 | 58 |
| MSCR, % recovery @ 3.2 kPa @ 58° C. | 1.6% | 0.9% |

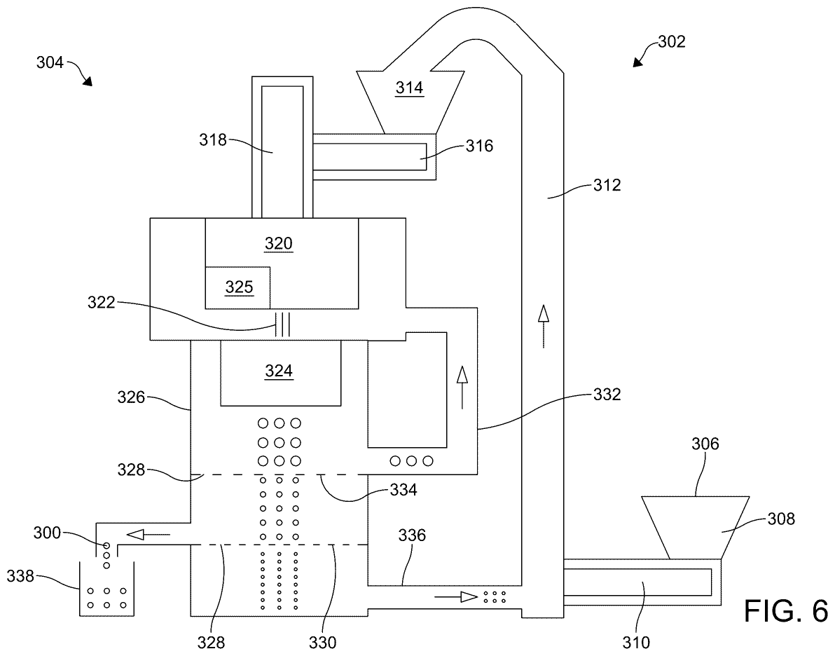

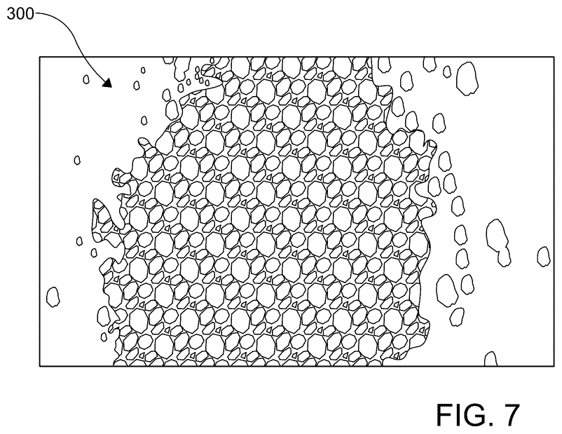

FIGS. 6 and 7 provide a schematic illustration of VAE pellets or granules 300 created using a roller compaction process 302 according to an embodiment of the disclosure. FIG. 6 provides a schematic illustration of a roller compaction machine 304 that may be used to create the VAE pellets or granules 300 according to an embodiment of the disclosure. It is within the scope of this disclosure and as a non-limiting example that the roller compaction machine 304 may be a dry granulation, dry compression and/or a slugging agglomeration process.

As illustrated in FIG. 6 and as a non-limiting example, the roller compaction machine 304 may include a first hopper 306 having an amount of the dispersible VAE co-polymer powder 308 therein. One or more first screws 310 feeds an amount of the VAE dispersible co-polymer powders 308 from the first hopper 306 into a first conduit 312. The dispersible VAE co-polymer powder 308 within the first conduit 312 are transported into a second hopper 314 located at an opposite end thereof having one or more second screws 316 therein. It is within the scope of this disclosure and as a non-limiting example, that the one or more first screws 310 and/or the one or more second screws 316 may be oriented in a substantially horizontal manner. Additionally, it is within the scope of this disclosure and as a non-limiting example that the dispersible VAE co-polymer powder 308 may be pure VAE or a substantially pure VAE co-polymer.

The one or more second screws 316 feed an amount of the dispersible VAE co-polymer powder 308 from the second hopper 314 to one or more third screws 318 that will then feed the VAE dispersible co-polymer powders 308 to a plurality of rollers 320. It is within the scope of this disclosure and as a non-limiting example that the one or more third screws 318 may be oriented in a substantially vertical manner.

As best seen in FIG. 6 of the disclosure and as a non-limiting example, the dispersible VAE co-polymer powder 308 provided by the one or more third screws 318 is brought into contract with the plurality of rollers 320 to form an amount of large format VAE pellets or granules 322.

The plurality of rollers 320 rotate at a pre-determined speed (or rpm) so as to apply an amount of compressive force and/or heat needed to transform the dispersible VAE co-polymer powder 308 into large format VAE co-polymers 322 having a substantially pellet, substantially cylindrical, substantially granule and/or substantially sheet-like shape. The large format VAE co-polymers 322 formed by the plurality of rollers 320 are then transferred to one or more shearing members 324. It is within the scope of this disclosure and as a non-limiting example that the large format VAE co-polymers 322 formed may be transferred to the one or more shearing members 324 via gravity.

It is within the scope of this disclosure and as a non-limiting example that the plurality of rollers 320 may have one or more cooling elements 325 added thereto. This aids in preventing the buildup of an amount of VAE on the outer surface of the plurality of rollers 320 which is undesirable. Additionally, the one or more cooling elements 325 aid in improving the overall efficiency and volume of large format VAE pellets or granules 300 that the roller compaction machine 304 can produce in a pre-determined amount of time. Furthermore, the one or more cooling elements 325 also aid in reducing the overall down time associated with cleaning and/or removing an amount of the VAE that may otherwise build up on the plurality of rollers 320.

In accordance with an embodiment of the disclosure and as a non-limiting example, the one or more cooling elements (not shown) may be added to an area surrounding the plurality of rollers 320. This aids in preventing the buildup of an amount of VAE on the outer surface of the plurality of rollers 320 that is undesirable. Additionally, this aids in improving the overall efficiency and volume of large format VAE pellets or granules 300 that the roller compaction machine 304 can produce in a pre-determined amount of time. Furthermore, the one or more cooling elements (not shown) also aid in reducing the overall down time associated with cleaning and/or removing an amount of the VAE that may otherwise build up on the plurality of rollers 320. As a non-limiting example, the one or more cooling elements (not shown) located within the area surrounding the plurality of rollers 320 may be used in place of or in combination with the one or more colling elements 325 within the plurality of rollers 320.

As illustrated within FIG. 6 of the disclosure and as a non-limiting example, the one or more shearing members 324 are operably configured to break down the large format VAE co-polymers 322 formed by the plurality of rollers 320 to a pre-determined or smaller particle size. It is within the scope of this disclosure and as a non-limiting example that the one or more shearing member 324 may be operably configured to break down the large format VAE co-polymers 322 formed by the plurality of rollers 320 to a size of approximately 0.2 mm to approximately 12.5 mm, preferably from approximately 0.5 mm to approximately 10.5 mm or more preferably from approximately 1.0 mm to approximately 8 mm.

According to an embodiment of the disclosure and as a non-limiting example, the roller compaction machine 304 may include one or more classifiers 326. The one or more classifiers 326 are used in order to ensure that the large format VAE pellets or granules 300 produced using the roller compaction method 302 have a pre-determined particle size.

The dispersible VAE co-polymer powder 308 and/or the large format VAE pellets or granules 322 not having the desired particle size are fed back into the roller compaction machine 304 one or more times until a large format VAE pellets or granules having the pre-determined particle size or falling within a pre-determined PSD is formed. This ensures that the roller compacted VAE pellets or granules produced have fall with a pre-determined PSD. It is within the scope of this disclosure and as a non-limiting example that this may be achieved by utilizing one or more meshes 328 having a plurality of openings therein having a pre-determined size.

It is within the scope of this disclosure and as a non-limiting example that the one or more classifiers 326 may include one or more meshes or one or more mesh zones 328. As illustrated in FIG. 6 of the disclosure and as a non-limiting example, the one or more meshes 328 may be oriented in a stacked manner one above the other with a space therebetween. In accordance with the embodiment illustrated in FIG. 6 of the disclosure and as a non-limiting example, the one or more classifiers 326 may include one or more first meshes 330. The one or more first meshes 330 may be operably configured to ensure that the large format VAE co-polymers 322 formed by the plurality of rollers 320 that are too large are able to be feed back to the one or more shearing members 324 to further reduce their size before passing further through the one or more classifiers 326. As best seen in FIG. 6 and as a non-limiting example the large format VAE co-polymers 322 formed by the plurality of rollers 320 that are too large may be fed from the one or more classifiers 326 to a location between the one or more rollers 320 and the one or more shearing members 324 by use of one or more second conduits 332.

According to an embodiment of the disclosure and as a non-limiting example, the one or more classifiers 326 may include one or more second meshes 334. The one or more second meshes 334 may be operably configured to ensure that the large format VAE co-polymers 322 formed by the plurality of rollers 320 that are too small or are otherwise smaller than the desired particle size for the final large format VAE pellets or granules 300 produced using the roller compaction method 302 are able to be feed back into the produced using the roller compaction method 302 for further processing until they reach the pre-determined desired particle size. It is within the scope of this disclosure and as a non-limiting example that the large format VAE co-polymers 322 formed by the plurality of rollers 320 that are too small may be fed from the one or more classifiers 326 to a location between the one or more rollers 320 and the second hopper 314. Additionally, it is within the scope of this disclosure and as a non-limiting example that the large format VAE co-polymers 322 formed by the plurality of rollers 320 that are too small may be fed from the one or more classifiers 326 to a location between first hopper 306 and the second hopper 314 by using one or more third conduits 336.

FIG. 7 provides a schematic illustration of an amount of the plurality of large format VAE pellets or granules 300 produced using the roller compaction method 302 described and illustrated herein.

In accordance with an embodiment of the disclosure and as a non-limiting example, the large format VAE pellets or granules 300 may be an ETONIS® 7622 A and/or 7601 A.

It is within the scope of this disclosure and as a non-limiting example that the large format VAE pellets or granules 300 may be a pure VAE or a substantially pure VAE co-polymer.

The large format VAE pellets or granules within one or more classifiers 326, exiting the one or more shearing members 320 and/or exiting the roller compaction machine 304 may be cooled as needed. It is within the scope of this disclosure and as a non-limiting example that the large format VAE pellets or granules 300 and/or 322 may be cooled using one or more coolers (not shown), air cooled on a conveyor belt and/or may be cooled by placing at least a portion of the large format VAE pellets or granules 300 and/or 322 within a water bath (not shown).

In accordance with an amount embodiment of the disclosure and as a non-limiting example, an amount of heat may be applied during the roller compaction process 302. As a non-limiting example, this may be achieved by adding one or more heating zones or elements (not shown) to the one or more first screws 310, the one or more second screws 316 and/or the one or more third screws 318. The one or more heating zones or elements (not shown) may be operably configured to subject the VAE material 308 to a pre-determined temperature. It is within the scope of this disclosure and as a non-limiting example that one or more of the one or more heating zones or elements (not shown) may be operably configured to heat the VAE material to approximately 120° C. to approximately 220° C. or more preferably from approximately 120° C. to approximately 160° C.

It is within the scope of this disclosure and as a non-limiting example that an amount of the VAE pellets or granules 300 produced using the roller compaction process 302 described and illustrated herein are free-flowing and do not agglomerate or otherwise collect or group together to form a larger mass. By providing large format VAE pellets or granules 300 that are free-flowing, it allows the large format VAE pellets or granules 300 to be reliably fed using a variety of feeding mechanisms and to be reliably and evenly mixed into a variety of products.

One benefit of the roller compaction process 302 described and illustrated herein, in comparison to the extrusion process 100 described and illustrated herein, is that large format VAE pellets or granules 300 resist agglomeration or otherwise collecting or grouping together for form a larger mass. As a result, it is within the scope of this disclosure and as a non-limiting example that the roller compaction process 302 does not require the use of the one or more anti-caking agents. This aids in reducing the overall costs and time associated with manufacturing the large format VAE pellets or granules 300.

However, in the event that the large format VAE pellets or granules 300 created using the roller compaction process 302 described and illustrated herein suffer from agglomeration or otherwise collecting or grouping together, it is within the scope of this disclosure and as a non-limiting example that one or more anti-caking agents (not shown) may be added to the dispersible VAE co-polymer powder 308, large format VAE co-polymers 322 formed by the plurality of rollers 320 and/or the large format VAE pellets or granules 300 produced using the roller compaction process 302. It is within the scope of this disclosure and as a non-limiting example that one or more first anti-caking agents (not shown) may be added at one or more locations between the first hopper 306 and the plurality of rollers 320. Additionally, it is within the scope of this disclosure and as a non-limiting example that one or more second anti-caking agents (not shown) may be added to the large format VAE pellets or granules 322 at any point between the plurality of rollers 320 and the packaging 338 of the large format VAE pellets or granules 300. Furthermore, it is within the scope of this disclosure and as a non-limiting example that the one or more first and/or second anti-caking agents (not shown) may be the same as those previously described herein. As a non-limiting example, the one or more first anti-caking agents (not shown) may be added at approximately 5% based on the weight of the dispersible VAE co-polymer powder and the one or more second anti-caking agents (not shown) may be added at approximately 0.5% to approximately 5% based on the weight of the large format VAE pellets or granules.

An additional benefit of the roller compaction process 302 described and illustrated herein, in comparison to the extrusion process 100 described and illustrated herein, is that the large format VAE pellets or granules 300 produced using the roller compaction process 302 are at least partially dispersible in water thereby allowing large format VAE pellets or granules 300 to be used in a wider array of products and/or applications.

It is within the scope of this disclosure and as a non-limiting example that the large format VAE pellets or granules 300 produced using the roller compaction process 302 may be further reduced to a pre-determined particle size as part of the one or more post treatment processes (not shown). The one or more post treatment processes (not shown) may also be utilized in order to alter the overall surface area, cross-sectional shape and/or overall shape of the large format VAE pellets or granules 300 thereby allowing the large format VAE pellets or granules 300 to be customized as needed.

Additionally, it is withing the scope of this disclosure and as a non-limiting example that the shearing, pelletizing and/or granulation processes of the roller compaction process 302 may be an underwater shearing, pelletizing and/or granulation process.

The large format VAE pellets or granules 300 produced using the roller compaction method 302 described and illustrated herein allow for a wide range of particle sizes while also significantly reducing undesirable combustible fines or dust. It is within the scope of this disclosure and as a non-limiting example that the undesirable fines and/or dust produced during the roller compaction process 302 may be recycled back into the compaction process 302 until desired large particle format is achieved. As a result, the large format VAE pellets or granules 300 produced using the roller compaction method 302 described and illustrated herein do not need to be classified as a hazardous combustion product according to Section 2.1 of Globally Harmonized System (GHS) on the safety data sheet.

Additionally, the large format VAE pellets or granules 300 produced using the roller compaction method 302 have a more consistent particle size distribution (PSD) as opposed to conventional methods. This is desirable for applications having tighter tolerances or requiring a specific particle size. It is within the scope of this disclosure and as a non-limiting example that the PSD may be from approximately 0.2 mm to approximately 12.5 mm.

Furthermore, the VAE pellets or granules 300 produced using the roller compaction method 302 do not negatively affect the overall bulk density when compared to the dispersible VAE co-polymer powders created using conventional methods. As a result, the large format VAE pellets or granules 300 produced using the roller compaction method 302 set forth herein are easily and safely packaged and transported.

Still further, the large format VAE pellets or granules produced 300 using the roller compaction method 302 set forth herein may have a moisture content of approximately 3% or less. This ensures that the overall shelf life and storage stability of the VAE pellets and/or granules 300 are not negatively impacted when compared to VAE dispersible co-polymer powders created using conventional methods. It is within the scope of this disclosure and as a non-limiting example that the moisture content of the large format VAE pellets or granules 300 may be reduced using one or more post drying processes (not shown). As a non-limiting example, the one or more post drying processes (not shown) may be achieved by placing an amount of the large format VAE pellets or granules into an oven and/or a drum dryer at approximately 80° C. to approximately 120° C. Preferably, the oven and/or the drum dryer is at approximately 95° C. to approximately 105° C.

It is within the scope of this disclosure and as a non-limiting example that the large format VAE pellets or granules 300 having the desired pre-determined particle size may be utilized as chemical products in the construction industry in conjunction with hydraulically setting binders such as cements (Portland cement, high-alumina cement, trass cement, glass furnace cement, magnesia cement, phosphate cement), gypsum and waterglass, for the production of construction adhesives, especially tile adhesives and thermal insulation composition system adhesives, renders, filling compounds, flooring compounds, levelling compounds, grouts, jointing mortars and/or paints. Further examples are as binders for coating materials and adhesive-bonding materials, or as coating agents and/or binding agents for textiles and/or paper. Additionally, it is within the scope of this disclosure and as a non-limiting example that the large format VAE pellets or granules 300 may be used within cementitious type products, asphalt related products, asphalt roofing products, high temperature applications, high shear applications and/or other construction related products.

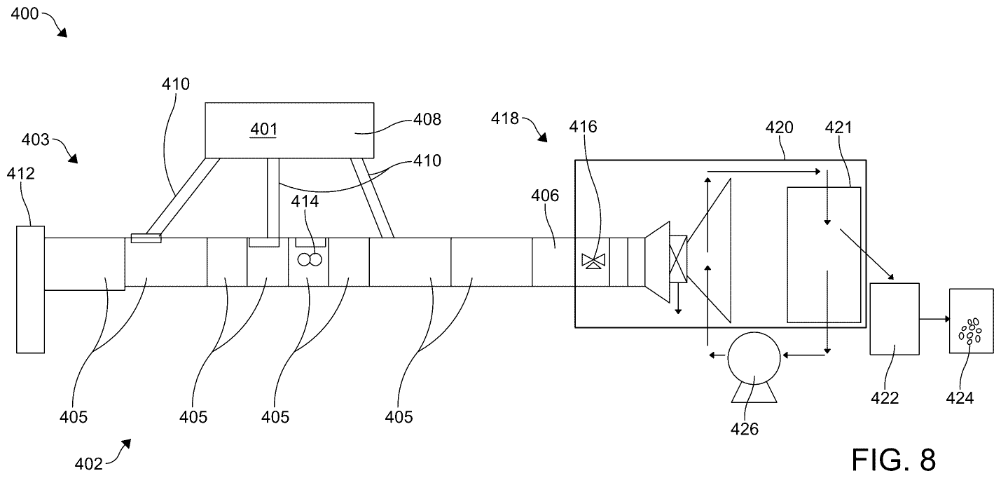

FIG. 8 provides a schematic illustration of a process 400 for producing an amount of large format VAE pellets or granules 424. In accordance with this embodiment of the disclosure and as a non-limiting example, the process 400 may include one or more first hoppers 401 that are connected to at least a portion of one or more barrel sections 405 of an extruder 403 having at least a portion of one or more screws 402 disposed therein. As a non-limiting example, the one or more screws 402 may include one or more screw elements (not shown) having one or more threads (not shown) that aid in transitioning an amount of a dispersible VAE co-polymer powder 408 from the one or more first hoppers 401 to one or more dies 406. The one or more screws 402 aid in applying a pre-determined amount of force and/or heat onto the dispersible VAE co-polymer powder 408 in order to transform the material from a powder form to an extruded form when exiting the one or more dies 406.

It is within the scope of this disclosure and as a non-limiting example that the one or more screws 402 may include one or more screw elements (not shown). The one or more screw elements (not shown) may be disposed in a substantially linear manner one after another from one or more driving mechanisms 412 toward one or more dies 406 along the length of the extruder 403. According to this embodiment of the disclosure and as a non-limiting example, the one or more screws 402, and the one or more screw elements (not shown) making up the one or more screws 402, may be drivingly connected to each other thereby allowing the one or more driving mechanisms 412 to drive the one or more screws 402 as needed to transform the dispersible VAE co-polymer powder 408 into the desired large format VAE pellets or granules 424.

Additionally, it is within the scope of this disclosure and as a non-limiting example that the one or more screws 402, and the one or more screw elements (not shown) making up the one or more screws 402, may be oriented adjacent to or off-set from one another similar to that of a twin-screw extruder. As a non-limiting example, the one or more screws 402, and the one or more screw elements (not shown) making up the one or more screws 402, may be off-set from one another in a substantially parallel manner, at an angle such that the one or more screws 402 and the one or more screw elements (not shown) making up the one or more screws 402 disposed near the one or more dies 406 are further from each other than the space between the one or more screws 402 and the one or more screw elements (not shown) making up the one or more screws 402 near the one or more drive mechanisms 412 or at an angle such that the one or more screws 402 and the one or more screw elements (not shown) making up the one or more screws 402 disposed near the one or more dies 406 are closer together than the space between the one or more screws 402 and the one or more screw elements (not shown) making up the one or more screws 402 near the one or more drive mechanisms 412. This may be done in order to apply an amount of heat, pressure and force needed to transform the dispersible VAE co-polymer powder 408 into the desired large format VAE pellets or granules 424 without negatively affecting the overall life durability and/or properties of the large format VAE pellets or granules 424 created using the process 400.

According to an embodiment of the disclosure and as a non-limiting example, the above-described orientations and arrangements for the one or more screws 402, and the one or more screw elements (not shown) making up the one or more screws 402, may be combined in order to transform the dispersible VAE co-polymer powder 408 into the desired large format VAE pellets or granules 424.

The extruder 403 may include one or more zones (not shown) which may be heated or cooled accordingly in an effort to transform the dispersible VAE co-polymer powder 408 into the desired large format VAE pellets or granules 424. As a non-limiting example, one or more of the one or more barrel sections 405 may define the one or more zones (not shown) of the extruder 403. The one or more zones (not shown) may have a pre-determined temperature profile needed to create the large format VAE pellets or granules 424 in a manner that will not negatively affecting the overall life durability and/or properties of the large format VAE pellets or granules 424 created using the process 400. While the temperature profiles do not negatively affect the viscosity of the dispersible VAE co-polymer powder 408, higher temperatures did result in a degradation of the overall tackiness, life, durability and/or properties large format VAE pellets or granules 424 created using the process 400. According to an embodiment of the disclosure and as a non-limiting example one or more of the one or more zones (not shown) may have a temperature profile of approximately 100° C. to approximately 220° C., from approximately 125° C. to approximately 200° C., from approximately 140° C. to approximately 190° C., from approximately 160° C. to approximately 175° C.

As illustrated in FIG. 8 and as a non-limiting example, it is within the scope of this disclosure and as a non-limiting example that the one or more first hoppers 401 may be connected to the one or more screws 402, and the one or more screw elements (not shown) making up the one or more screws 402, of the extruder 403 at one or more locations using one or more conduits 410 that are operably configured to deliver a pre-determined amount of the dispersible VAE co-polymer powder 408 to the extruder 403. As a non-limiting example, the one or more conduits 410 may be operably configured to deliver a pre-determined amount of one or more anti-caking agents (not shown) to be mixed with the dispersible VAE co-polymer powder 408 within the extruder 403. It is within the scope of this disclosure and as a non-limiting example that the one or more anti-caking agents (not shown) may be the same as the one or more first and/or second anti-caking agents described previously herein.

Drivingly connected to at least a portion of an end portion of the one or more screws 402 opposite the one or more dies 406 is one or more driving mechanisms 412. The one or more driving mechanisms 412 may be anything that is capable of rotating the one or more screws 402 and the one or more screw elements (not shown) making up the one or more screws 402 at a pre-determined speed.

According to an embodiment of the disclosure and as a non-limiting example, the extruder 403 may include one or more cooling devices 414. The one or more cooling devices 414 may be operably configured to release an amount of heat from the dispersible VAE co-polymer powder 408 within the extruder 403. This aids in preventing degradation of the dispersible VAE co-polymer powder 408 and/or the one or more anti-caking agents (not shown) during the process 400.

Disposed adjacent to an end of the one or more dies 406 opposite the one or more screws 402 is one or more shearing members 416. The one or more shearing members 416 may be operably configured to break down the extruded VAE co-polymers (not shown) exiting the one or more dies 406 into large format VAE pellets or granules (not shown) having a pre-determined or smaller particle size. It is within the scope of this disclosure and as an on-limiting example that the one or more shearing members 416 may be operably configured to break down the extruded VAE co-polymers (not shown) exiting the one or more dies 406 to a size of approximately 0.2 mm to approximately 12.5 mm, preferably from approximately 0.5 mm to approximately 10.5 mm or more preferably from approximately 1.0 mm to approximately 8 mm.

It is within the scope of this disclosure and as a non-limiting example that at least a portion of the one or more shearing members 416 may be located within an amount of liquid (not shown) within a bath 420. As a result, the pelletizing process may be an underwater pelletizing process 418. According to an embodiment of the disclosure and as a non-limiting example, the liquid may be subjected to one or more filtering processed in order to remove all or substantially all of the debris and/or impurities therefrom. This is done in order to ensure that the liquid bath 420 does not add any contaminants into the large format VAE pellets or granules (not shown) produced from the process 400 that may have a negative effect on the properties, performance and/or life of the large format VAE pellets or granules 424 produced using the extrusion process 400 described and illustrated herein. As a non-limiting example, the liquid (not shown) within the liquid bath 420 may be water.

Once the large format VAE pellets or granules (not shown) have exited the one or more shearing members 416, they may be transported through the liquid bath 420 to one or more driers 421. The one or more driers 421 may be operably configured to remove all or substantially all of the liquid (not shown) from the large format VAE pellets or granules (not shown) created by the one or more shearing members 416. It is within the scope of this disclosure and as a non-limiting example that the one or more driers 421 may be one or more ovens and/or one or more drum dryers. As a non-limiting example, the one or more driers 421 may heat up the large format VAE pellets or granules (not shown) created by the one or more shearing members 416 to approximately 80° C. to approximately 120° C. Preferably, the one or more driers 421 may be set at approximately 95° C. to approximately 105° C.

After the large format VAE pellets or granules (not shown) have exited the one or more driers 421 they are then transported to one or more classifiers 422. The one or more classifiers 422 are used in order to ensure that the large format VAE pellets or granules 424 produced using the extrusion process 400 have a pre-determined particle size.

According to an embodiment of the disclosure and as a non-limiting example the liquid (not shown) within the liquid bath 420 may include a pre-determined amount of the one or more anti-caking agents (not shown) therein. As the large format VAE pellets or granules (not shown) travel within the liquid bath 420 an amount of the one or more anti-caking agents (not shown) may be coated on the outer surface of the large format VAE pellets or granules (not shown) and/or absorbed within the large format VAE pellets or granules (not shown).

According to an embodiment of the disclosure and as a non-limiting example, the underwater pelletizing process 418 may include one or more pumps 426. The one or more pumps 426 may be operably configured to circulate the liquid within the liquid bath 420 and/or through the one or more driers 421. Additionally, the one or more pumps 426 may be operably configured to transport an amount of the large format VAE pellets or granules (not shown) by the one or more shearing members 416 back to the one or more shearing members 416 until the pre-determined particle size large format VAE pellets or granules 424 has been achieved.

It is within the scope of this disclosure and as a non-limiting example that the underwater pelletizing process 418 may be utilized within the processes 100 as described and illustrated herein.

It is to be understood that the various embodiments described within this specification and as illustrated within the attached drawings are simply exemplary embodiments illustrating the inventive concepts as defined within the claims. As a result, it is to be understood that the various embodiments described and illustrated herein may be combined to form the inventive concepts defined within the appended claims.

In accordance with the provisions of the patent statutes, the present invention has been described to represent what is considered to represent the preferred embodiments. However, it should be noted that this invention can be practiced in other was than those specifically illustrated and described without departing from the spirit or scope of this invention.

1-24. (canceled)

25. A process for producing large format vinyl acetate ethylene (VAE) co-polymers, comprising:
providing VAE co-polymers in the form of aqueous dispersions stabilized by one or more protective colloids;
drying of said aqueous dispersions of VAE co-polymers in the presence of protective colloids to obtain VAE co-polymers in the form of water-redispersible powders, wherein the drying of the aqueous dispersions is carried out by fluidized-bed drying, freeze drying or spray drying;
providing an amount of said dispersible VAE co-polymer powders;
inserting an amount of said dispersible VAE co-polymer powders into an extruder; and
forming an amount of large format VAE pellets or granules.

26. The process of claim 25, wherein the large format VAE pellets or granules produced are free flowing and/or eliminates or reduces the amount of combustible VAE dispersible co-polymer fines and/or dust produced; or
wherein the large format VAE pellets or granules produced are pure or substantially pure VAE co-polymers such that only vinyl acetate and ethylene monomers and no other monomers are present.

27. The process of claim 25, wherein the large format VAE pellets or granules produced have a cylindrical, egg, ellipsoid, oval and/or ovoid shape.

28. The process of claim 25, wherein the large format VAE pellets or granules produced have a particle size of approximately 0.2 mm to approximately 12.5 mm, preferably from approximately 0.5 mm to approximately 10.5 mm or more preferably from approximately 1.0 mm to approximately 8 mm.

29. The process of claim 25, wherein the large format VAE pellets or granules produced have a moisture content of approximately 3% or less.

30. The process of claim 25, wherein the extruder has one or more zones having a pre-determined temperature profile; and
wherein the pre-determined temperature profile heats the dispersible VAE co-polymer powders to approximately 100° C. to approximately 220° C., from approximately 125° C. to approximately 200° C., from approximately 140° C. to approximately 190° C., from approximately 160° C. to approximately 175° C.

31. The process of claim 25, further comprising an underwater pelletizing process.

32. The process of claim 31, wherein the underwater pelletizing process comprises one or more shearing members, a bath, one or more driers and/or one or more pumps;
wherein the one or more shearing members are operably configured to break down the extruded dispersible VAE co-polymer into smaller pieces; and
wherein the one or more driers are operably configured to reduce the moisture content of the large format VAE pellets or granules produced have a moisture content of approximately 3% or less.

33. The process of claim 31, further comprising providing one or more classifiers; and
wherein the one or more classifiers are operably configured to output large format VAE pellets or granules having a pre-determined particle size.

34. The process of claim 25, further comprising providing one or more pigments, fillers, foam stabilizers, hydrophobicizing agents and/or cement plasticizers; and
adding the one or more pigments, fillers, foam stabilizers, hydrophobicizing agents and/or cement plasticizers to the dispersible VAE co-polymer powders.

35. The process of claim 25, wherein the large format VAE pellets or granules produced are combined with hydraulically setting binders such as cements, gypsum and/or waterglass, for the production of construction adhesives; or
wherein the large format VAE pellets or granules produced are used within cementitious type products, asphalt related products, asphalt roofing products and/or other construction related products.

36. A process for producing large format vinyl acetate ethylene (VAE) co-polymers, comprising:
providing VAE co-polymers in the form of aqueous dispersions stabilized by one or more protective colloids;
drying of said aqueous dispersions of VAE co-polymers in the presence of protective colloids to obtain VAE co-polymers in the form of water-redispersible powders, wherein the drying of the aqueous dispersions is carried out by fluidized-bed drying, freeze drying or spray drying;
providing an amount of said dispersible VAE co-polymer powders;
inserting an amount of said dispersible VAE co-polymer powders into a roller compaction machine; and
forming an amount of large format VAE pellets or granules.

37. The process of claim 36, wherein the roller compaction machine includes a plurality of rollers that are disposed adjacent to one another;
wherein an amount of the dispersible VAE co-polymer powders are fed between the plurality of rollers; and
wherein the plurality of rollers transform the dispersible VAE co-polymer powders into a plurality of large format VAE co-polymers.

38. The process of claim 37, further comprising providing one or more shearing members;
wherein the one or more shearing members are operably configured to break down the plurality of large format VAE co-polymers formed by the plurality of rollers into smaller pieces.

39. The process of claim 38, wherein the plurality of large format VAE co-polymers formed by the one or more shearing members have a particle size approximately 0.2 mm to approximately 12.5 mm, preferably from approximately 0.5 mm to approximately 10.5 mm or more preferably from approximately 1.0 mm to approximately 8 mm; or
wherein the plurality of large format VAE co-polymers formed by the one or more shearing members have a moisture content of approximately 3% or less.

40. The process of claim 38, wherein the plurality of large format VAE co-polymers formed by the one or more shearing members have a cylindrical, egg, ellipsoid, oval and/or ovoid shape; or
wherein the plurality of large format VAE co-polymers formed by the one or more shearing members are free flowing and/or eliminates or reduces the amount of combustible VAE dispersible co-polymer fines and/or dust produced; or
wherein the plurality of large format VAE co-polymers formed by the one or more shearing members are pure or substantially pure VAE co-polymers such that only vinyl acetate and ethylene monomers and no other monomers are present.

41. The process of claim 36, further comprising providing one or more classifiers;
wherein the one or more classifiers are operably configured to output large format VAE co-polymers having a pre-determined desired particle size.

42. The process of claim 41, further comprising feeding an amount of the large format VAE co-polymers having a size larger than the pre-determined desired particle size fed back into the roller compaction machine at a location between the plurality of rollers and one or more shearing members; and/or
feeding an amount of the large format VAE co-polymers having a size larger than the pre-determined desired particle size back into the roller compaction machine at a location before the plurality of rollers.

43. The process of claim 38, further comprising providing one or more pigments, fillers, foam stabilizers, hydrophobicizing agents and/or cement plasticizers; and
adding the one or more pigments, fillers, foam stabilizers, hydrophobicizing agents and/or cement plasticizers to the dispersible VAE co-polymer powders.

44. The process of claim 38, wherein the large format VAE co-polymers produced are combined with hydraulically setting binders such as cements, gypsum and/or waterglass, for the production of construction adhesives; or
wherein the large format VAE pellets or granules produced are used within cementitious type products, asphalt related products, asphalt roofing products and/or other construction related products.
